(19) United States
(12) Patent Application Publication
(10) Pub. No.: US 2012/0017578 A1
(43) Pub. Date: Jan. 26, 2012

(54) Power transfer system

(76) Inventors: Daniel S. Johnson, Loveland, CO (US); Kenneth E. Netzel, Loveland, CO (US); Daniel Jude Hueber, Fort Collins, CO (US); Christopher A. Pennekamp, Fort Collins, CO (US); Jonathan L. Reynolds, Fort Collins, CO (US)

(21) Appl. No.: 12/932,805

(22) Filed: Mar. 7, 2011

Related U.S. Application Data
(60) Provisional application No. 61/311,168, filed on Mar. 5, 2010.

(51) Int. Cl. F16H 47/06

(52) U.S. Cl. 60/330

(57) ABSTRACT

Embodiments relate to systems and methods for transferring power from a vehicle drive train to a hydraulic pump. One aspect of the present invention provides system including a torque converter; a torque converter hub connected to at least the torque converter; and a synchronous drive system coupled to at least the torque converter.

### CLAIM FOR PRIORITY

This application claims priority from U.S. Provisional Application Ser. No. 61/311,168 filed Mar. 5, 2010, the complete subject matter of which is incorporated herein by reference in its entirety.

### CROSS-REFERENCE TO RELATED APPLICATIONS

The following related patent application, assigned to the same assignee hereof and filed on the same date herewith in the names of the same inventors as the present application, disclose related subject matter, the complete subject matter of which is incorporated herein by reference in its entirety: ACCUMULATOR/RESERVOIR SYSTEM, U.S. Ser. No. ______ (Attorney Docket No. 4510.9).

### FIELD OF THE INVENTION

The invention relates to power transfer in vehicles. More particularly, embodiments relate to systems and methods for transferring power from a vehicle drive train to a hydraulic pump.

### BACKGROUND OF THE INVENTION

The transfer of energy to or from a hydraulic pump (in a hybrid system, for example) involves energy losses and may not provide optimal operation between given power sources (i.e. engine and hydraulic pump). Some of the largest losses are due to the rotational mass of the engine. Another appreciable loss is due to the rotational mass of the hydraulic pump (applicable during operation at highway speeds for example).

One known solution is to use engine cylinder deactivation. While such cylinder deactivation reduces the energy losses due to operational backpressure, this method does not address the energy losses due to the rotating mass.

For the foregoing reasons, it would be desirable to provide a system and method that provides for transfer power from a vehicle drive train to a hydraulic pump that overcomes the above disadvantages.

### SUMMARY OF THE INVENTION

One aspect of the present invention relates to a system for transferring power from a vehicle transmission to a vehicle hydraulic pump. The system comprises a first clutch drive cup adapted to move between an activated mode engaging the transmission and a deactivated mode. A first clutch is adapted to activate and deactivate the first clutch drive cup; while a first synchronous pulley is coupled to at least the first clutch drive cup. A second clutch drive cup is adapted to move between an activated mode engaging the hydraulic pump and a deactivated mode. A second clutch is adapted to activate and deactivate the second clutch drive cup; while a second synchronous pulley is coupled to at least the second clutch cup. A synchronous belt couples the first synchronous pulley and the second synchronous pulley.

Another aspect of the present invention relates to a system for transferring power. The system includes a torque converter; a torque converter hub connected to at least the torque converter; and a synchronous drive system coupled to at least the torque converter.

Another aspect of the present invention relates to a system for transferring power from a vehicle drive system to a vehicle fluid power system. The system includes a power torque converter connected to the vehicle drive system; a torque converter hub connected to at least the power torque converter; and a synchronous drive system coupled to at least the power torque converter whereby power is transferred between at least the vehicle drive system and the vehicle fluid power system.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 is a perspective view in accordance with the present invention;

FIG. 2 is a block diagram in accordance with the present invention;

FIG. 3 is a cross-sectional view of a power transfer module in accordance with one embodiment of the present invention;

FIG. 4 is a cross-sectional view of a power transfer module in accordance with another embodiment of the present invention;

FIG. 5 is another cross-sectional view of the power transfer module of FIG. 4 in accordance with another embodiment of the present invention;

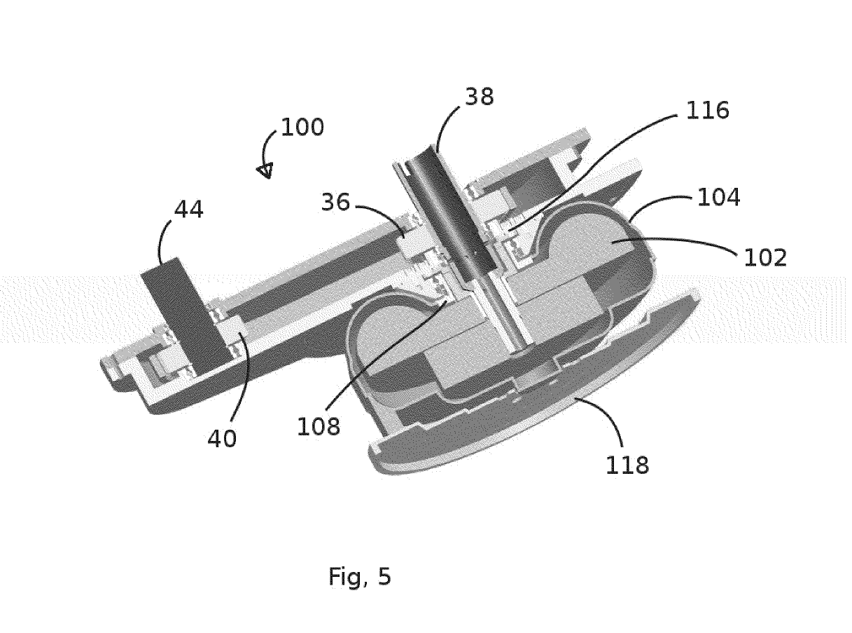

FIG. 6 is a exploded view of the power transfer module of FIG. 4 in accordance with another embodiment of the present invention;

FIG. 7 is an another view of the torque converter and torque converter hub of the power transfer module of FIG. 4 in accordance with the present invention.

Throughout the various figures, like reference numbers refer to like elements.

### DETAILED DESCRIPTION OF PRESENTLY PREFERRED EMBODIMENTS

Embodiments of the present invention may be applied to any vehicle having an automatic transmission and some means for power to be transferred from the output of that transmission to the drive wheel. In the conventional system, the vehicle has an internal combustion engine or some other type of prime mover coupled to the input of the transmission. The power transfer module in at least one embodiment is installed between the prime mover and the transmission. In accordance with one embodiment, an arrangement of two fluid clutches and a synchronous belt/pulley scheme are used during a regenerative braking cycle to transfer power from a vehicle's drive train to a hydraulic pump, or in the case of an acceleration cycle, the same arrangement transfers power from the hydraulic pump to the drive train. In another embodiment, a torque converter is used with the synchronous belt/pulley scheme to transfer power for the drive train to the hydraulic pump and back. One skilled in the art would appreciate that, in the transfer of energy between various power sources (i.e. engine and hydraulic pump), energy losses should be minimized during acceleration or braking. Embodiments of the present invention provide for recovery of braking energy while minimizing energy losses at cruising or highway speeds for example.

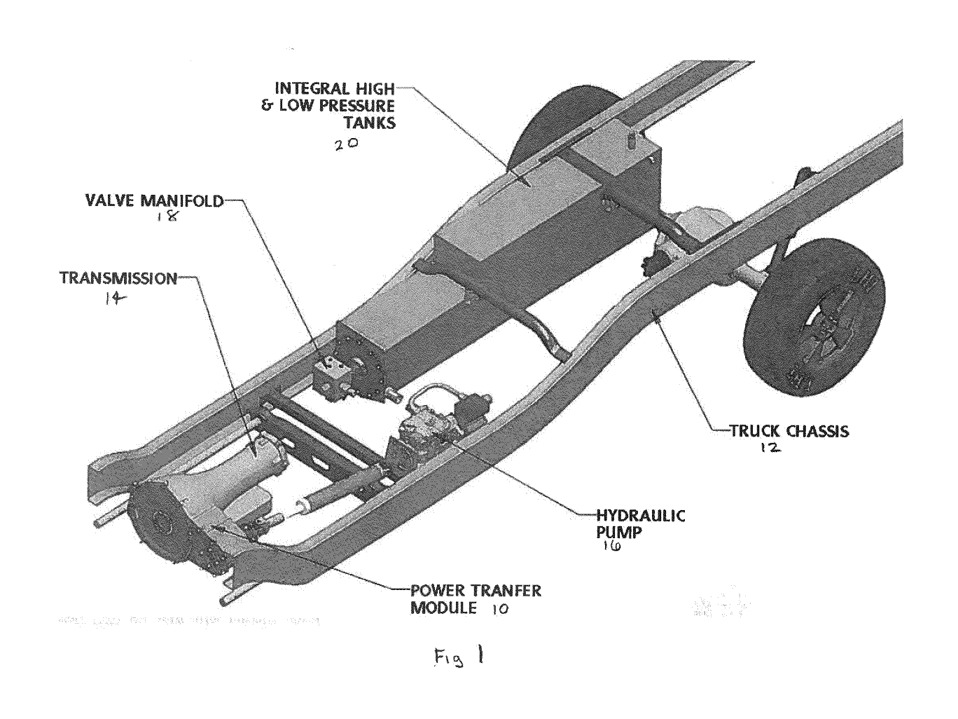

FIG. 1 is a perspective view illustrating a power transfer module (alternatively referred to as “PTM”), generally designated 10, coupled or joined to chassis or frame 12. The PTM 10 is used to transfer power from a vehicle's drive train or transmission 14 to a hydraulic pump 16 in accordance with the present invention. FIG. 1 further illustrates a valve manifold 18 and integral high and low pressure tanks 20 coupled or joined to chassis 12.

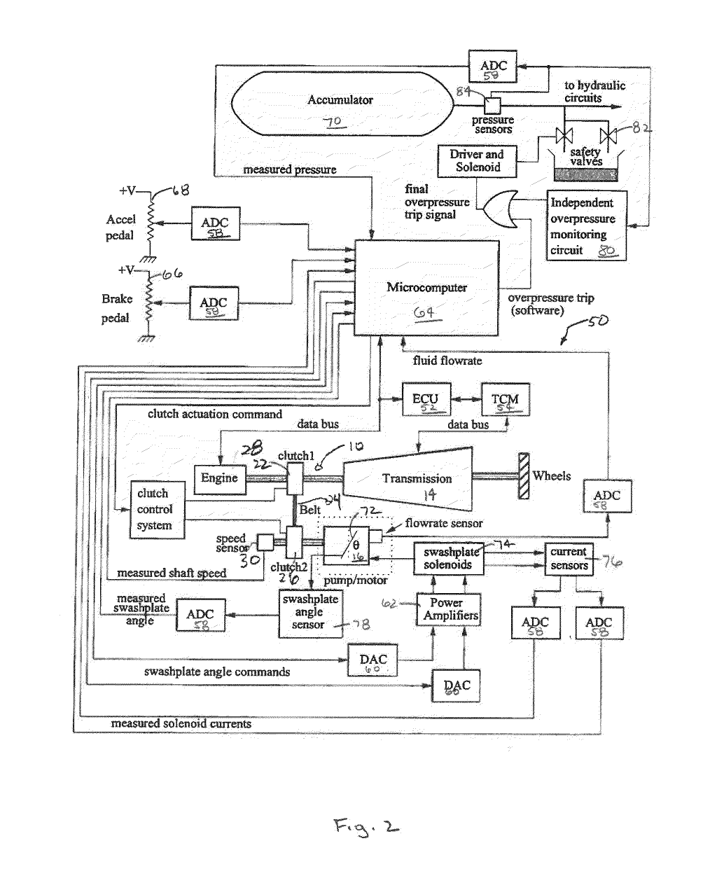

FIG. 2 is a block diagram which depicts power transfer module 10 in accordance with one embodiment of the present invention. A digital automatic control system 50 coordinates and sequences all tasks required to interface the operation of the electrohydraulic subsystems with the existing vehicle subsystems. In at least one embodiment, the digital automatic control system 50 includes data exchange between the Electronic Control Unit (ECU) 52, the Transmission Control Module (TCM) 54 and the Hydraulic Control Interface (HCI) 56. The HCI 56 consists of the devices that communicate with the hydraulic system such as one or more Analog to Digital Converters (ADCs) 58, one or more Digital to Analog Converters (DACs) 60 and one or more power amplifiers 62 for example.

In one embodiment, the core of the control system 50 is a microcomputer 64 running a set of discrete-time sampled-data control algorithms which perform sensor monitoring and actuator command activities. A top-level supervisory algorithm is responsible for coordinating a number of subsystems, each managing its own set of measurement and control algorithms.

All of the functions described previously are, in one embodiment, executed automatically by the control system 50. Without extremely precise control, a regenerative braking system cannot function at the efficiency levels needed to make it an economically viable addition to a vehicle system. One feature of the controller 50 is the manner in which it is integrated into the vehicle system. In order to make the system salable for post vehicle production application, the control system 50 must be integrated with the vehicle but handled by a separate controller.

The task of incorporating the necessary software in to the engine control unit 52 or other existing onboard computer 64 would be enormous. Also, it is unlikely that a computer 64 is able to pick up the extra computing overhead. To make the system as transparent as possible, it is desirable to reduce the number of extra control inputs for the user. Therefore, in accordance with one embodiment of the present invention, the control system 50 uses positions of the brake 66 and accelerator pedals 68 that the driver of the vehicle is already familiar with as input signals. These signals from the brake 66 and accelerator pedals 68 are used to inform the engine control unit 50 of the throttle position, which is used as a power demand input, telling the pump 16 how much power to add to the system while still fulfilling its function within the normal vehicle system. The controller 50 then determines how much energy is stored in the accumulator 70 and determines how it will use that power to meet the demand from the user. By monitoring the pressure and volume in the accumulator 70, the controller 50 can determine the best gear ratio for the transmission 14 based on the available torque the pump 14 can provide. A pedal position sensor (not shown) is added to the brake pedal 66 to provide accurate braking demand inputs to the controller 50.

As illustrated in FIG. 2, the accumulator 70 pressure, hydraulic pump/motor shaft 60 speed, accelerator 68 position, brake 66 position, fluid flowrate, solenoid currents, and swashplate 72 angle are periodically sampled by ADCs 58. In one embodiment, such sampling is performed in a sequential “round-robin” fashion at a fixed sample rate of fs Hz. The digitized signals are fed to the microcomputer 64 for processing by a set of measurement and control algorithms.

The energy stored in the accumulator 70 is monitored continuously by the control system 50 so that energy efficiency is maximized during all modes of vehicle operation. In at least one embodiment, the energy stored in the accumulator is determined by the pressure and volume measurements.

The hydraulic pump/motor 14 is controlled by turning or rotating a swashplate 72 through a given angle in order to control the volumetric flowrate of hydraulic fluid passing to or from the pump/motor 14. The swashplate 72 movement is controlled by two solenoids 74. In at least one embodiment, each solenoid 74 controls the opening of a valve which allows control pressure to move a piston connected to one side of the swashplate 72. Each solenoid 74 is responsible for rotating the swashplate 72 in a particular (opposing) direction; one rotates clockwise from center position to control the pump operating mode and the other rotates counterclockwise from center position to control the motor operating mode. Since the force exerted by the magnetic field of the solenoid 74 is proportional to the applied current, a current control system 76 is used to supply an accurate current to each solenoid 74.

The swashplate 72 angle is measured by a potentiometer 78 and fed to a closed loop servocontroller (not shown in FIG. 2) which feeds the current control circuit 76 and enables a precise swashplate angle to be obtained from the command voltage. In at least one embodiment, the angle command voltage signal is determined by control algorithms in the firmware and delivered to the swashplate angle controller as a digital signal. The swashplate angle controller consists of two feedback loops. The inner feedback loop consists of a closed loop solenoid current controller with discrete-time digital compensator Gc(z). The outer feedback loop is a standard position servo system with compensator Gs(z). The overall system ensures that the measured swashplate position θm(z) accurately tracks the commanded angle position θs(z).

During both braking and accelerating modes, the digital control system 50 controls the flow of hydraulic fluid via the swashplate angle and rotational speed, thereby controlling the flow of energy through the vehicle drivetrain system. The controller 50 includes an overpressure safety system 80 to prevent the accumulator pressure from rising above a specified value. The safety system 80 is multiply redundant and consists of a mechanical safety release valve 82, two independent pressure sensors 84 as well as two separate circuits that monitor the pressure sensors (via a majority voting scheme) and open the electrically operated safety valve 82 when required. In the event of a firmware failure, the auxiliary trip circuit opens the valve 82.

During braking, energy is recovered by rerouting the braking energy from the vehicle's normal braking system and storing it as pressure in the gas bladder of the accumulator. In this way, instead of losing braking energy in the form of heat, the energy is stored in compressed nitrogen gas for later re-use during acceleration.

The microcomputer 64 monitors the position of the brake pedal 66 to determine the desired level of braking. The output signals of the vehicle's normal braking system are processed by a blending algorithm, which determines how to apportion braking force obtained from accumulator 70 pressure with that obtained from brake drum friction. The digital control system 50 monitors how much pressure the accumulator 70 has available and, based on the amount of braking desired, decides how much brake regeneration to apply.

In at least one embodiment, a brake pedal mechanism is used which incorporates a deadband nonlinearity into the overall braking system characteristic. The deadband is inserted at the beginning of the pedal's travel, so that for a specified initial portion of the travel, the normal braking system is effectively disconnected from the overall system until the threshold D is reached. Pedal travel beyond D results in a gradual addition of vehicle braking force. The braking force from the hydraulic system FH is added to the normal vehicle braking force FN to provide a combined braking force which acts on the mass M of the vehicle.

The vehicle deceleration α(z) is measured with an accelerometer and the value obtained is compared with the commanded deceleration value αd(z) obtained from the brake pedal position. A digital deceleration control system with discrete-time digital compensator GB(z) is used to control the hydraulic braking force via the swashplate angle servocontroller.

A separate emergency braking algorithm measures the brake pedal displacement and rate of movement and uses a peak detector and threshold comparator to determine if an emergency braking situation exists. In an emergency, the hydraulic braking system is effectively switched out causing the overall system to default to the vehicle's normal braking system. In this manner, the entire hydraulic braking system becomes transparent to it, allowing all features of an ABS system to work completely unhindered.

The top-level supervisory algorithm ensures that a specified minimum accumulator pressure is maintained, so that residual energy is always available for assistance with acceleration.

There are two modes of operation relating to acceleration:
1. acceleration from standstill; and
2. acceleration during forward motion.

The acceleration control algorithm monitors the accelerator pedal position sensor and determines the amount of acceleration desired. The vehicle's normal acceleration system is “drive-by-wire”, in the sense that the pedal position generates a command signal for use by the vehicle's Electronic Control Unit (ECU). In this case, any modification of the accelerator command signal (such as adding a nonlinearity) can be implemented electronically without requiring any special linkages or adaptations to the existing pedal.

In the acceleration control system gain blocks Kv and Kh are the vehicle and hydraulic system scaling gains used to balance the acceleration torque magnitudes of the two systems. To ensure that stored energy is used before resorting to engine power, an adjustable deadband nonlinearity Dα, which is a function of the stored energy E and the pedal command value Φ, is used.

The amount of stored energy available is proportional to the pressure and volume of gas in the accumulator. The control system uses the desired acceleration and stored energy values to calculate the optimum swashplate command profile suitable to provide the required accelerating torque on the wheels of the vehicle in the most energy efficient way. The energy minimization algorithm takes measured acceleration, pedal position, fluid flowrate, shaft speed and accumulator pressure as inputs and uses them to calculate the best value of the variable Dα(E,Φ). When sudden, large accelerations are required, the value of Dα(E,Φ) can be large initially, allowing almost all of the extra energy stored in the accumulator to be quickly used to accelerate the vehicle until the pressure drops below a prescribed value.

The clutches illustrated in FIG. 2 are operated pneumatically and consist of proportional servo valves operating to control pneumatic pressure in the clutch, thereby controlling the clutching force. The valve opening is controlled by an electrically operated solenoid with actuation current controlled by a closed loop pressure control system which enables the force applied by the clutch to be accurately controlled by a voltage command signal.

FIG. 2 illustrates power transfer module 10 including a first, engine or inboard clutch 22 coupled to a second, pump or outboard clutch 26 via belt 24. The inboard clutch 22 is shown coupled or in operable communication with transmission 14 and engine 28, while the outboard clutch 23 is shown coupled or in operable communication with pump 16.

FIG. 2 further illustrates the inboard clutch 22 enables isolation of the engine 28 from either cycle for example, while the outboard clutch 26 enables isolation of pump 16 during standard highway operation for example. The belt 24 and pulley scheme (not shown in FIG. 2) provides the mechanical link between the two clutches 22 and 26.

One important feature of the PTM 10 is the two wet clutches 22, 26 that essentially replace the torque converter in an automatic transmission, providing large efficiency gains by enabling engine shutdown, and pump motoring without losses inherent to the movement of the internal combustion engine. FIG. 2 illustrates load paths that are possible because of the PTM's two clutches. A minimum energy level is always maintained in the accumulator so that the pump 16 can be used to speed match the engine 28 and transmission 14. With the inboard clutch 22 disengaged, the engine 28 is completely disengaged from the drivetrain. Engaging the outboard clutch 26 couples the pump 16 to the drive-train. The pump 16 can produce its full torque at zero rotational speed. It can easily be coupled to the transmission 14 as they are both at zero rotational speed. Further clutch 22 doesn't require slippage in order to bring the transmission 14 and vehicle up to speed. As a fail safe mode so that the vehicle is still drivable if the pump 16 or some other part of the system is disabled, the integrated controller uses an engine load signal from the engine 29 to control engagement of inboard clutch 22 enabling the vehicle to operate as a semi-automatic transmission.

During a regenerative braking cycle, the inboard clutch 22 is deactivated allowing a clutch drive cup to spin freely. With the clutch drive cup directly linked to the crankshaft of engine 28 through the shaft interface, the engine 28 is isolated. With the inboard clutch 22 and inboard pulley directly coupled to the transmission 14 through the interface sleeve, all the braking energy is transmitted to the outboard pulley through the synchronous belt 24. Additionally, the outboard clutch 26 (which is directly coupled to the hydraulic pump shaft) is activated, locking up the outboard drive cup (which is fixed to the outboard pulley) enabling the inputted energy to be transferred directly into the hydraulic pump 16, where the braking energy is then recovered.

During an acceleration cycle, the inboard clutch 22 is deactivated, and the outboard clutch 26 is activated with the same effect, except that the input energy is supplied from the hydraulic pump 16. The energy flows on the identical path as above but in the opposite direction. The energy transfers back through the drive train, accelerating the vehicle. However, other embodiments are contemplated for the acceleration cycle in which the inboard clutch 22 and outboard clutch are both activated.

During normal highway driving, the inboard clutch 22 is activated, while the outboard clutch 26 is deactivated. With the inboard clutch 22 activated the engine 28 is directly coupled to the transmission 14. Though the synchronous pulley system is still active, with the outboard clutch 26 deactivated, the hydraulic pump 16 is decoupled from the system. Other embodiments are contemplated for the normal highway driving cycle in which the inboard clutch 22 and outboard clutch 26 are both activated.

The PTM 10 enables the engine 28 or hydraulic pump 16 to be utilized independently or together in any combination. By allowing the engine 28 to shutdown at braking and the pump 16 to recover braking energy, efficiency gains may be realized. The ability to declutch the engine 28 during a braking cycle also reduces or eliminates engine rotational mass energy losses and engine back pressure energy losses. Additionally, during standard highway operation, the pump 16 is isolated, reducing or eliminating pump rotational mass energy losses.

Table 1 provides possible scenarios illustrating clutch operation and control module status.

TABLE 1

| Vehicle Function | Engine Clutch | Pump Clutch | ACS State | ECU State | TCM State |
|---|---|---|---|---|---|
| Idle in park | Disengaged | Disengaged | Passive | Normal | Normal |
| Idle in drive | standby if HP empty | engaged if HP full | Active Acceleration | see chart | Normal |
| Accelerating with pump | Disengaged | engaged | Active Acceleration | see chart | Normal |
| Transition from pump | Disengaged to | engaged to | Active to passive | Piggybacked to | Piggybacked to |
| to engine power | engaged | disengaged | | normal | normal |
| Braking with full | engaged | Disengaged | Passive | Normal | Normal |
| accumulator | | | | | |
| Regenerative braking | Disengaged | engaged | Active Braking | Piggybacked | Piggybacked |

* A passive ACS state replicates normal vehicle operation.
* An active ACS state provides controlled pump integration
* A normal ECU or TCM state means they are getting “real” signals unmodified from the ACS

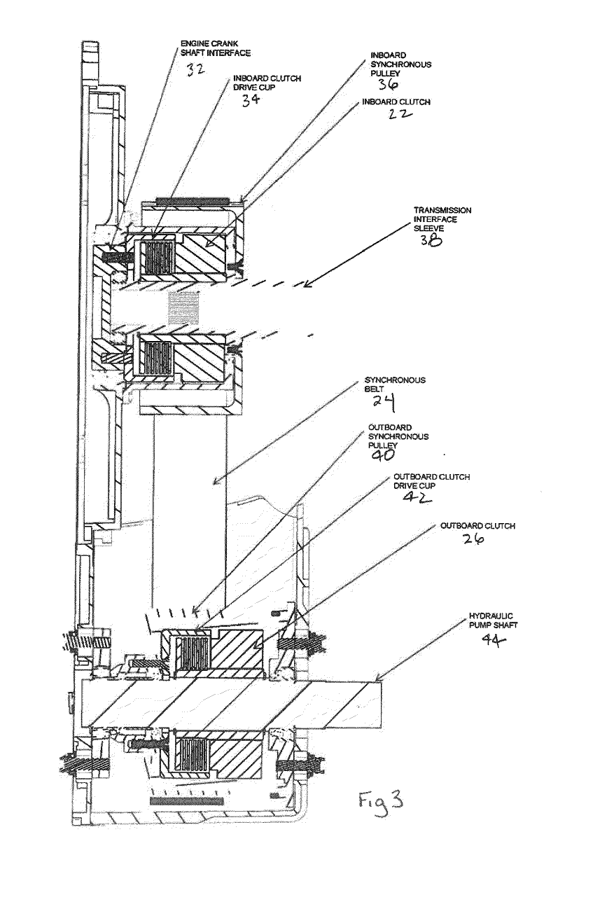

FIG. 3 is a cross-sectional view of the PTM 10 in accordance with the present invention. As illustrated, PTM 10 includes first clutch module coupled to an engine crank shaft interface 32 and operably connected to a second clutch module such that power is transferred from the vehicle transmission to the vehicle hydraulic pump. More specifically, the first clutch module includes first, engine or inboard clutch 22 operably coupled to a first or inboard clutch drive cup 34 and adapted to activate and deactivate the inboard clutch drive cup 34, such that the inboard clutch drive cup 34 moves between an activated mode, engaging transmission 14 through transmission interface sleeve 38, and a deactivated mode, disengaged from the transmission 14. The first clutch module further includes a first or inboard synchronous pulley 34 operably coupled to at least the inboard clutch drive cup 34.

As illustrated, the second clutch module includes second, pump or outboard clutch 26 operably coupled to a second or outboard clutch drive cup 42 and adapted to activate and deactivate the outboard clutch drive cup 36, such that the outboard clutch drive cup 42 moves between an activated mode, engaging the pump 16 through hydraulic pump shaft 44, and a deactivated mode, disengaged from the pump 16. The second clutch module likewise includes a second or outboard synchronous pulley 40 operably coupled to at least the outboard clutch drive cup 42. A synchronous belt or drive device 24 operably couples the first synchronous pulley 34 and the second synchronous pulley 40.

During a regenerative braking cycle, the inboard clutch 22 is deactivated allowing inboard clutch drive cup 34 to spin freely. With the clutch drive cup 34 directly linked to the crankshaft of engine 28 through the shaft interface 32, the engine 28 is isolated. With the inboard clutch 22 and inboard pulley 36 directly coupled to the transmission 14 through the interface sleeve 38, all the braking energy is transmitted to the outboard pulley 40 through the synchronous belt 24. Additionally, the outboard clutch (which is directly coupled to the hydraulic pump shaft 44) is activated, locking up the outboard drive cup 42 (which is fixed to the outboard pulley 40) enabling the inputted energy to be transferred directly into the hydraulic pump 16, where the braking energy is then recovered.

During the acceleration cycle, the inboard clutch 22 is deactivated, and the outboard clutch 26 is activated with the same effect, except that the input energy is supplied from the hydraulic pump 16. The energy flows on the identical path as above but in the opposite direction. The energy transfers back through the drive train, accelerating the vehicle. As provided, other embodiments are contemplated for the acceleration cycle in which the inboard clutch 22 and outboard clutch 26 are both activated.

During normal highway driving, the inboard clutch 22 is activated, while the outboard clutch 26 is deactivated. With the inboard clutch 22 activated the engine 28 is directly coupled to the transmission 14. Though the synchronous pulley system is still active, with the outboard clutch 26 deactivated, the hydraulic pump 16 is decoupled from the system. Again, other embodiments are contemplated for the normal highway driving cycle in which the inboard clutch 22 and outboard clutch are both activated.

The PTM 10 enables the engine 28 or hydraulic pump 16 to be utilized independently or together in any combination. By allowing the engine 28 to shutdown at braking and the pump 16 to recover braking energy, efficiency gains may be realized. The ability to declutch the engine 28 during a braking cycle also reduces or eliminates engine rotational mass energy losses and engine back pressure energy losses. Additionally, during standard highway operation, the pump 16 is isolated, reducing or eliminating pump rotational mass energy losses.

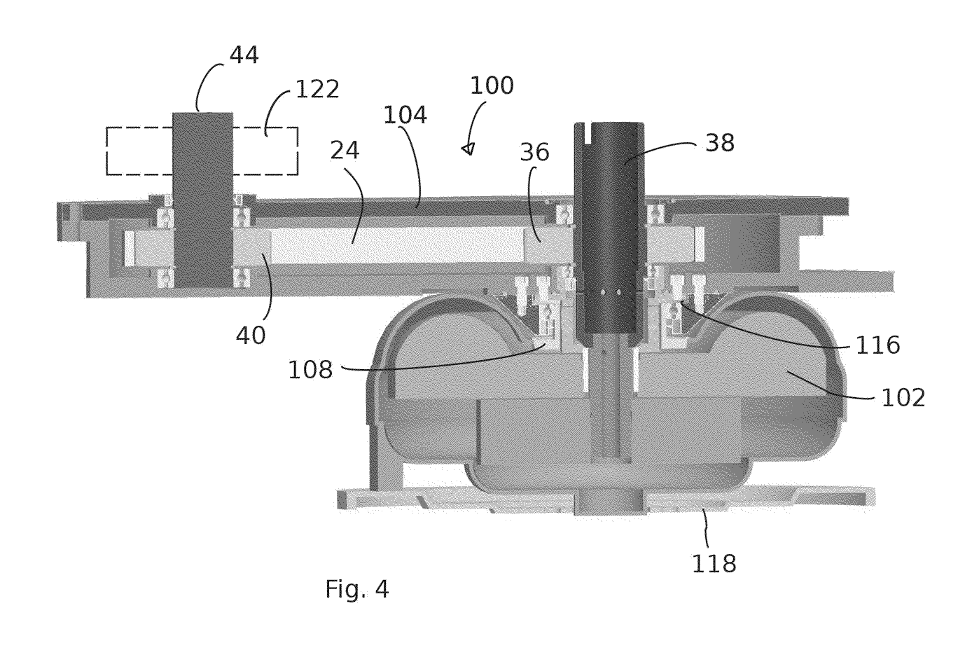

FIGS. 4 & 5 depict cross-sectional views of a power transfer module, generally designated 100, in accordance with one embodiment of the present invention. Power transfer module 100 is similar in many ways to the power transfer module 10 as provided above. As illustrated, PTM 100 includes a torque converter 102 in contact with or in proximity to a housing or case 104 which contains a synchronous drive system 106. In at least one embodiment, the synchronous drive system 106 includes a first or inboard synchronous pulley 34, a second synchronous pulley 40 and the synchronous belt 24 similar to that provided previously. It should be appreciated that the synchronous drive system may include belt and pulleys as illustrated or chain and sprockets and the like. FIG. 4 illustrates the system 100 may additionally include a clutch 122, similar to clutch 22 discusses. As illustrated, the engine, via torque converter 102 and transmission input shaft, engages the pump 16 through hydraulic pump shaft 44 and synchronous drive system 106.

During a regenerative braking cycle, inboard pulley 36 is directly coupled to the transmission 14 through the interface sleeve 38, such that all the braking energy is transmitted to the outboard pulley 40 through the synchronous belt 24. In at least one embodiment, the outboard clutch 122 (which is directly coupled to the hydraulic pump shaft 44) is activated, enabling the inputted energy to be transferred directly into the hydraulic pump 16, where the braking energy is then recovered.

During the acceleration cycle, the input energy is supplied from the hydraulic pump 16. The energy flows on the identical path as above but in the opposite direction. The energy transfers back through the drive train, accelerating the vehicle.

During normal highway driving, the engine 28 is directly coupled to the transmission 14. Though the synchronous drive system 106 is still active and the hydraulic pump 16 is decoupled from the system via the outboard clutch 122.

The PTM 100 enables the engine 28 or hydraulic pump 16 to be utilized independently or together in any combination. By allowing the engine 28 to shutdown at braking and the pump 16 to recover braking energy, efficiency gains may be realized. The ability to declutch or disengage the engine 28 during a braking cycle, via the loose fluid coupling of the torque converter or a sprague, also reduces or eliminates engine rotational mass energy losses and engine back pressure energy losses. Additionally, during standard highway operation, the pump 16 is isolated, reducing or eliminating pump rotational mass energy losses.

When the vehicle is at rest, the transmission 14 will also be at rest or have zero rotational speed. In order for an internal combustion engine 28 to produce any torque it must be running at some rotational speed greater than zero. The transmission 14 and vehicle must slowly be brought up to the same speed so that the engine 28 can build enough torque to drive the vehicle and so that a rapid shock load doesn't occur and break mechanical components or cause the driver to lose control. The hydraulic pump/motor unit can produce torque at zero rotational speed. If a minimum amount of pressurized fluid is kept in the accumulator, the pump 16 will exert a specific torque on the transmission 14 based on its displacement setting. At low displacement settings, the pump 16 has a low torque and at higher displacement settings has a higher torque, such that the overall value is proportional to the pressure that the accumulator is putting on the pumps working port. Controlling this displacement enables the pump 16 to accelerate the vehicle smoothly. The transmission 14 may be left in neutral and the engine 28 used to rotate the pump 16, to build up stored energy. Then acceleration may be handled strictly by the pump 16.

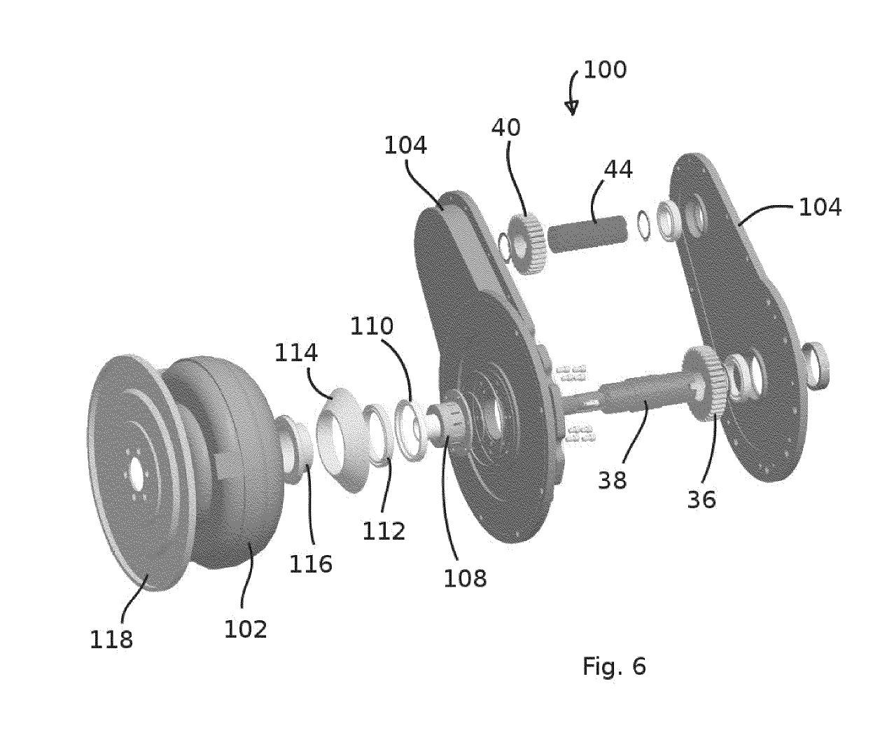

FIG. 6 is an exploded view of the power transfer module 100 of FIG. 4 in accordance with another embodiment of the present invention. FIG. 6 illustrates the PTM 100 includes the housing or case 104 containing the first or inbound synchronous pulley 36 connected to the transmission interface sleeve 38, and the second or outbound synchronous pulley 40 connected to the hydraulic pump shaft 44. FIG. 6 further illustrates the PTM 100 further includes a stator 108, a bearing 110, a seal 112, hub interface 114 and a torque converter hub 116 connected to at least one of the transmission interface sleeve 38 and torque converter 102. FIG. 6 further illustrates a flex plate 116 coupled to the torque converter 102 to the engine.

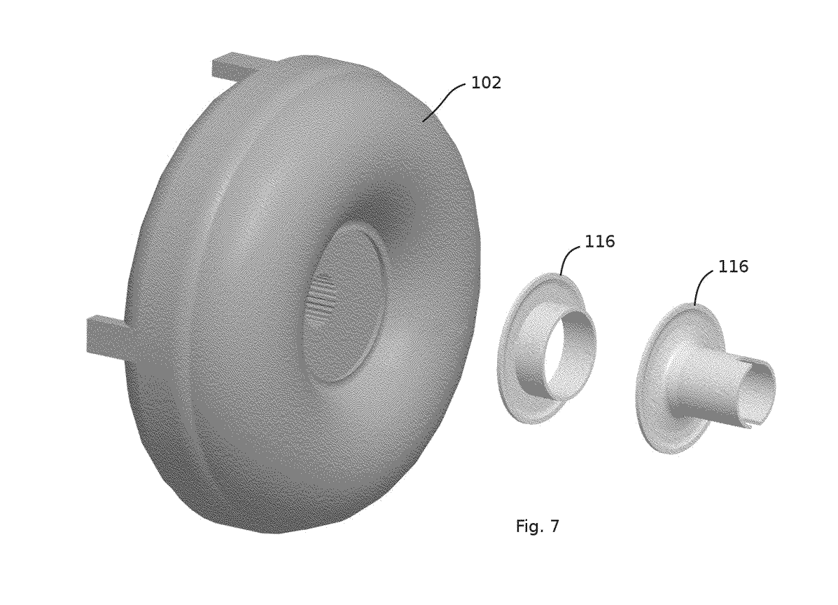

FIG. 7 is an another view of the torque converter and torque converter hub of the power transfer module 100 of FIG. 4 in accordance with the present invention. FIG. 8 illustrates the torque converter 102 and torque converter hub 116.

This power transfer modules 10/100 include many unique features that make it an efficient device enabling regenerative braking using a hydraulic pump/motor. On top of the features provided above such as engine decoupling, engine shutoff, and combining pump and engine power, the present invention enables putting the pump power through a mechanical gear reduction or increase without adding any extra components. Because the pump/motor is positioned before the transmission, its torque is multiplied by the transmission depending on what gear is selected. Part of the control scheme for this device controls the transmissions shift patterns to optimize the energy use depending on whether the engine or the pump is powering the vehicle. The transmission is shifted during braking events so that the pump can be pumping in its most efficient modes of operation and the maximum amount of energy can be stored. Because of the torque multiplication the hydraulic system as a whole can be down sized, which is part of what makes this system economically and physically practical.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A system comprising:
a torque converter;
a torque converter hub connected to at least the torque converter; and
a synchronous drive system coupled to at least the torque converter.

2. The system of claim 1 wherein the synchronous drive system comprises a first synchronous pulley connected to at least the torque converter.

3. The system of claim 2 further comprising an interface sleeve connected to at least one of the first synchronous pulley, the torque device and the torque converter hub.

4. The system of claim 2 wherein the synchronous drive system further comprises a second synchronous pulley.

5. The system of claim 5 further comprising a hydraulic pump shaft connected to the second synchronous pulley.

6. The system of claim 4 further comprising a synchronous belt rotatably coupling the first synchronous pulley and the second synchronous pulley.

7. The system of claim 6 further comprising a housing containing at least the synchronous belt, the first synchronous pulley and the second synchronous pulley.

8. A system for transferring power from a vehicle drive system to a vehicle fluid power system, the system comprising:
a power torque converter connected to the vehicle drive system;
a torque converter hub connected to at least the power torque converter; and
a synchronous drive system coupled to at least the power torque converter, whereby power is transferred between at least the vehicle drive system and the vehicle fluid power system.

9. The system of claim 1 further wherein the synchronous drive system comprises a first synchronous pulley connected to at least the power torque converter.

10. The system of claim 9 further comprising an interface sleeve connected vehicle drive system and at least one of the first synchronous pulley, the power torque device and the torque converter hub.

11. The system of claim 10 wherein the synchronous drive system further comprises a second synchronous pulley.

12. The system of claim 11 further comprising a hydraulic pump shaft connected to the second synchronous pulley and the vehicle fluid power system.

13. The system of claim 12 further comprising a synchronous belt rotatably coupling the first synchronous pulley and the second synchronous pulley.

14. The system of claim 13 further comprising a housing containing at least the synchronous belt, the first synchronous pulley and the second synchronous pulley.
